(19) United States
(12) Patent Application Publication
(10) Pub. No.: US 2002/0164996 A1
(43) Pub. Date: Nov. 7, 2002

(54) Method and apparatus in a wireless communication system for determining a location of a mobile station

(75) Inventor: Jheroen P. Dorenbosch, Paradis, TX (US)

Correspondence Address: MOTOROLA INC, 5401 NORTH BEACH STREET, MAILSTOP E230, FORT WORTH, TX, 76137

(73) Assignee: MOTOROLA, INC.

(21) Appl. No.: 09/850,314

(22) Filed: May 7, 2001

(51) Int. Cl. H04Q 7/20

(52) U.S. Cl. 455/456; 342/450; 701/200

(57) ABSTRACT

A plurality of reporting devices (108, 110) and a location server (106) obtain (502) and store location information corresponding to a target MS (108) in a wireless communication system (100). A portion of the system (100) defines (504) a subset of the plurality of reporting devices near the target MS. A location server (106) elicits (506) the location information corresponding to the target MS from the subset, and combines (508) portions of the location information to determine the location of the target MS.

### FIELD OF THE INVENTION

This invention relates in general to wireless communication systems, and more specifically to a method and apparatus in a wireless communication system for determining a location of a mobile station.

### BACKGROUND OF THE INVENTION

The ability to determine the location of a mobile station is becoming increasingly important. Several new and upcoming applications, e.g., emergency medical services applications, query a wide area wireless system, such as a cellular telephone system, for the location of the mobile station from which a call for assistance is received. Many methods exist to determine the location of the mobile station while it is within coverage of the wireless system. Unfortunately, it is difficult to determine the location of the MS when it is out of coverage. Furthermore, the MS may sometimes be unable to precisely determine its location even while in coverage of the wireless system. For example, if the MS uses the Global Positioning System (GPS) for location determination, the GPS may not perform well in some locations.

Thus, what is needed is method and apparatus that can determine and report the location of the MS when it is out of coverage of the wireless system or when the MS cannot determine its location with sufficient accuracy. Preferably, the accuracy of the location reported by the method and apparatus disclosed herein will be reasonably high under most conditions.

### BRIEF DESCRIPTION OF THE DRAWINGS

FIG. 1 is an electrical block diagram of a wireless communication system in accordance with the present invention.

FIG. 2 is an electrical block diagram of a mobile station (MS) in accordance with the present invention.

FIG. 3 is an electrical block diagram of a fixed reporting device (FRD) in accordance with the present invention.

FIG. 4 is an electrical block diagram of a location server (LS) in accordance with the present invention.

FIG. 5 is a flow diagram depicting operation of the wireless communication system in accordance with the present invention.

### DETAILED DESCRIPTION OF THE DRAWINGS

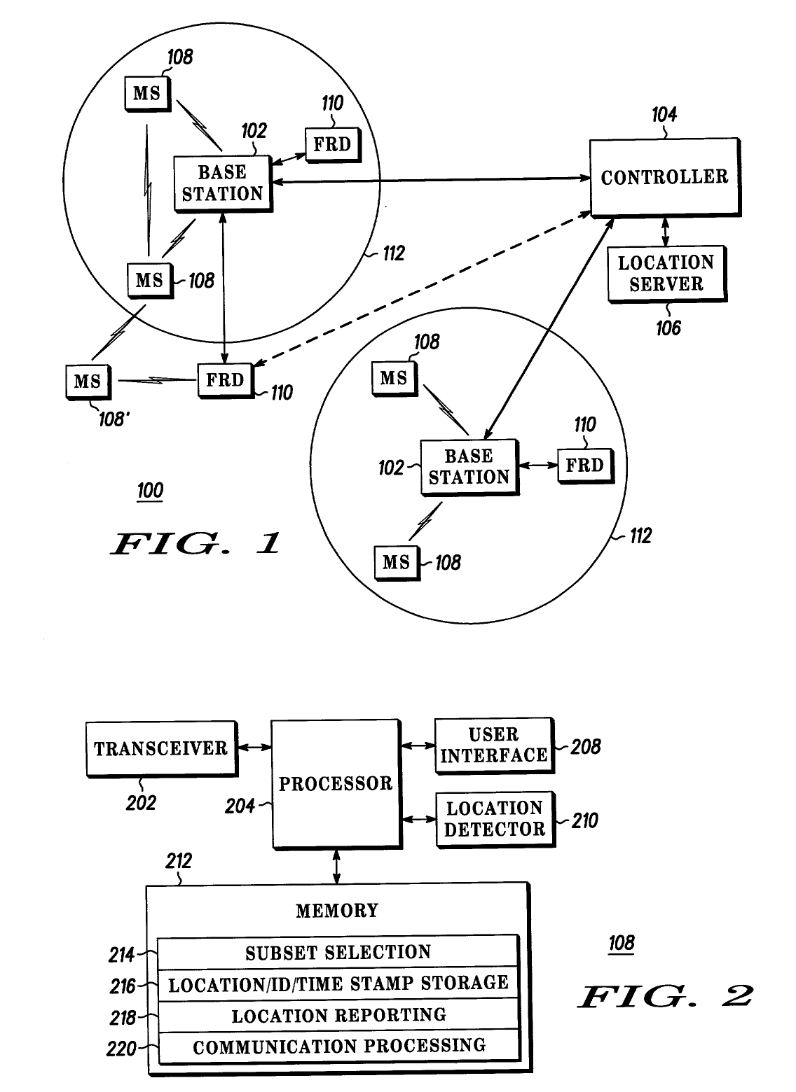

Referring to FIG. 1, an electrical block diagram depicts a wireless communication system 100 in accordance with the present invention, comprising a plurality of conventional base stations 102 coupled to a controller 104 for controlling the plurality of base stations 102 to communicate with a plurality of mobile stations (MSs) 108, such as cell phones, through conventional RF techniques. Each of the plurality of base stations 102 can communicate with MSs that are positioned within the base station's coverage area 112. The wireless communication system 100 further comprises a plurality of fixed reporting devices (FRDs) 110 in accordance with the present invention, each of which is coupled to one the base stations 102, preferably via a hardwire link for communicating with a location server (LS) 106 coupled to the controller 104. It will be appreciated that, alternatively, the FRD 110 can be coupled to one of the base stations 102 via an RF link. It will be further appreciated that the FRD 110 optionally can be coupled directly to the controller 104 for communicating with the LS 106.

In accordance with the present invention, the plurality of MSs 108 are arranged to communicate with each other and with the plurality of FRDs 110 over a short-range link, such as a link, a HomeRF link, an 802.11 link, or the ad-hoc network links of a 4G system. Each MS 108 preferably includes a location element for determining the location of the MS 108. An MS 108 that is within one of the base station coverage areas 112 of the system 100 periodically communicates its current location to the base station 102 which then forwards the current location to the LS 106 for storage and time stamping therein. MSs 108 that are within short-range-link communication range of each other preferably also exchange location information periodically with each other. The location information preferably includes the current location of the sending MS. MSs 108 that are within short-range-link communication range of one of the FRDs 110 also preferably communicate similar location information to the FRD. The location information optionally can include the velocity (speed and direction) of the MS 108. The receiving MS 108 or FRD 110 preferably stores the location information along with the identifier of the MS and a time stamp. The stored information enables the receiving MS 108 or FRD 110 to become a member of a select group of reporting devices that may be asked in the future to help locate the sending MS 108.

When the system 100 needs to determine the location of a target MS 108, the system 100 first will try a prior-art measurement technique. This technique is expected to fail, for example, when the target MS 108 is out of coverage, or when an on-board location detector is temporarily inaccurate. When the system 100 fails to obtain location information from the target MS 108, it retrieves location information for the target MS 108 from the LS 106. The system 100 then preferably extrapolates previously recorded locations and time stamps to get a rough estimate of the current location of the target MS 108. Next, the system queries collaborating MSs 108 for recent information on the location of the target MS 108. In effect, the MSs 108 that have communicated with the target MS 108 become “mobile reporting devices,” which in combination with the FRDs 110 form a plurality of “reporting devices,” as defined herein. Preferably, a selective method is used that directs the query only to those reporting devices that were within a given distance from a given location after the time of the last location measurement for the target MS 108. The system 100 then uses the result from such a query to make an improved location estimate. The preceding technique may be applied iteratively to get more recent location measurements and to get increasingly accurate location estimates.

When no more recent location information can be obtained, or when the newest measurement is very recent, the system 100 extrapolates and reports the extrapolation result as the target MS's location. The system 100 preferably also estimates, through well-known techniques, the resolution of the extrapolation based upon the data used for the extrapolation.

It will be appreciated that, alternatively, many variations can be made to the technique described herein above. For example, the system 100 can measure and store not only location, but also velocity and direction. Velocity and direction can then be used for improved extrapolation of the location of the target MS. In addition, when the range of a connection between MSs 108 is small, the querying MSs can store their own location at the time of contact, rather than storing a location provided by the target MS 108. Also, when an MS 108 detects that it is about to run out of coverage, the MS 108 preferably reports its location to the system 100.

Another variation is that when an MS 108 is queried for the last known location of a target MS 108, the queried MS 108 will try to contact the target MS 108. If the queried MS succeeds in contacting the target MS, it queries the target MS for its location. If the target MS cannot measure location, and the connection range is short, the queried MS can report its own location.

Yet another variation is that the system 100 can keep a list of locations where MSs 108 often disappear from coverage, only to appear in a remote location (the airport, for example). When the apparent location of an MS 108 is near such locations, the system 100 estimates a larger uncertainty in the location. The system 100 preferably learns about such spots from the location measurements themselves.

FIG. 2 is an electrical block diagram of the MS 108 in accordance with the present invention. The MS 108 comprises a conventional transceiver 202 for communicating with the system 100. The transceiver 202 preferably can be controlled to operate on at least two frequency bands and with at least two power levels, so that the transceiver 202 can communicate in both a wide area system, e.g., cellular, and a short range system, e.g., Bluetooth, HomeRF, 802.11, or the ad-hoc networks of a 4G system. It will be appreciated that, alternatively, the MS 108 can replace the transceiver 202 with two separate transceivers, one for the wide area system, and the other for the short-range system. The MS 108 further comprises a conventional processor 204 coupled to the transceiver 202 for controlling the transceiver 202 in accordance with the present invention. In addition, the MS 108 includes a conventional user interface 208 for interfacing with a user, and a conventional location detector 210 for determining the location of the MS 108. The MS 108 also includes a conventional memory 212 for storing operating software and variables utilized in accordance with the present invention. The memory 212 comprises a subset selection program 214 for programming the processor 204 to define a subset of the plurality of reporting devices, i.e., the MSs 108 and the FRDs 110, that have knowledge of recent location information for a target MS 108. In one embodiment, the reporting devices know their own locations, and the subset is defined independently by the reporting devices according to a set of subset-selection rules. For example, the subset-selection rules can specify that the subset shall include the plurality of reporting devices whose locations are less than a predetermined distance from the target MS, based upon the location information received from the target MS 108 and the reporting devices' own locations. It will be appreciated that the subset-selection rules can be pre-programmed into the reporting devices. Alternatively, the subset-selections rules, or a portion thereof, can be dynamically adjusted by the system 100, depending upon parameters such as traffic distribution and density of reporting devices.

In another embodiment, the system 100 knows, e.g., from location information stored in the location server 106, a cell or an area in which the target MS 108 was last located. (It will be appreciated that, as used herein, the word “cell” also can be interpreted to mean a sector of a cell.) The system then defines the subset to include all the plurality of reporting devices that it expects to be within range of that cell or area, and instructs any MS 108 or FRD 110 in the subset having communicated recently with the target MS 108 to respond with the location information of the target MS 108. Note that, in this embodiment, the definition of the subset itself does not require participation from the reporting devices—a portion of the system 100 exclusive of the plurality of reporting devices performs the definition of the subset.

In yet another embodiment, the system defines a time period, and then defines the subset to be all reporting devices which obtained location information corresponding to the target MS during the time period. This advantageously can help keep the location information sent by the reporting devices fresh.

The memory 212 further comprises a location and time stamp storage area 216 for storing location information received from communicating MSs 108. The location information preferably comprises the location and identifier of the communicating MS 108 and a time stamp indicating the time at which the location information was received. The location information is preferably obtained by communicating with other MSs 108 via a short-range link. The short-range link advantageously limits the traffic to that of near-by MSs 108, and does not add traffic to the wide-area system channels. In one embodiment, the location of the reporting device is stored as an estimate of the location of the communicating MS 108. (The error will be small, because the link range is short.) This advantageously reduces computation and traffic on the short-range link, as the communicating MS 108 does not have to determine and send its location.

The memory 212 further comprises a location reporting program 218 for programming the processor 204 to report the location information corresponding to a target MS 108, in response to a request from the system 100 to the reporting device (MS 108 or FRD 110) to report the location information corresponding to the target MS 108. When the reporting device has location information for the target MS 108, the location information is reported to the system. When the reporting device does not have the location information for the target MS 108, or when the location information is older than a predetermined age, the reporting device preferably will attempt to contact the target MS 108 to determine the location of the target MS 108, in response to receiving the request.

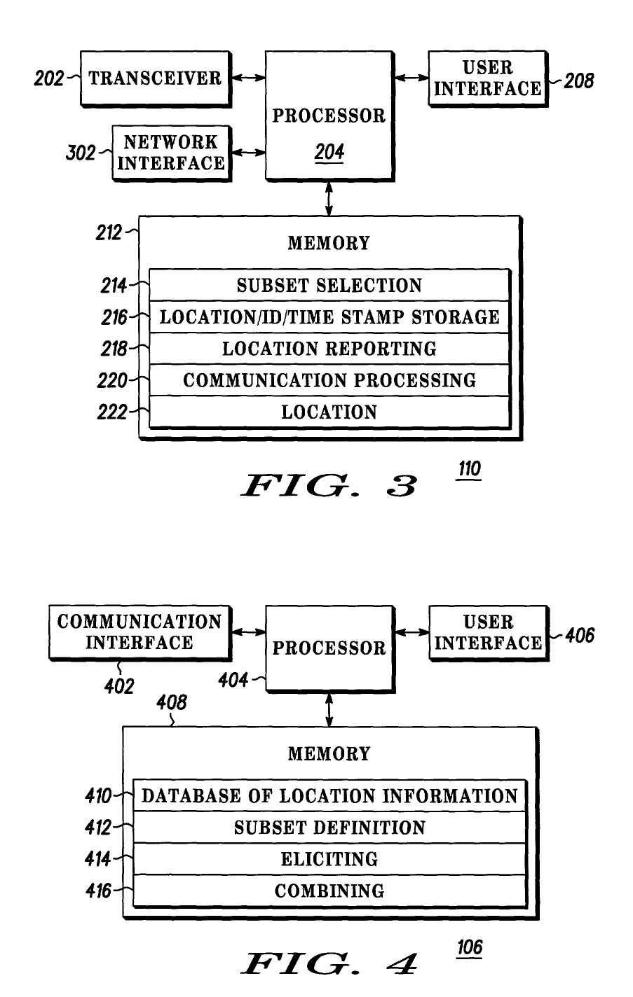

FIG. 3 is an electrical block diagram of the fixed reporting device (FRD) 110 in accordance with the present invention. The FRD 110 is similar to the MS 108, the essential differences being the addition of a conventional network interface 302 for communicating with a wired network to facilitate reporting of location information received from an MS 108, and the elimination of the location detector 210. The location detector 210 is preferably replaced with a location 222 preprogrammed into the memory 212, the location corresponding to that of the FRD 110. It will be appreciated that, in an alternative embodiment, the network interface 302 can communicate with a wireless network, such as a WLAN. The operation of the FRD 110 is similar to that of the MS 108 in regard to obtaining and storing location information corresponding to a target MS 108, and then reporting the location information to the location server 106 when requested by the system 100 to do so. The essential operational differences are that the FRD 110 operates from a substantially fixed position and usually through a wireline network.

FIG. 4 is an electrical block diagram of the location server (LS) 106 in accordance with the present invention. The LS 106 comprises a conventional communication interface 402 for communicating with other portions of the wireless communication system 100. The LS 106 further comprises a conventional processor 404 coupled to the communication interface 402 for controlling the LS 106. The processor 404 preferably controls the communication interface 402 to communicate with a target MS and with a plurality of reporting devices comprising other MSs 108 and FRDs 110 to obtain location information corresponding to the target MS. The LS 106 also preferably includes a conventional user interface 406 for interfacing with a user. In addition, the LS 106 includes a memory 408 for storing operating software and variables in accordance with the present invention.

The memory 408 comprises a database of location information 410 for storing location information provided from the MSs 108 and the FRDs 110 in the system 100. The location information preferably comprises a location, a corresponding MS identifier, and a time stamp corresponding to the time the location information was reported. The memory 408 further comprises a subset definition program 412 for programming the processor 404 to define a subset of the plurality of reporting devices. In one embodiment, the LS 106 defines the subset to include the plurality of reporting devices whose locations are less than a predetermined distance from the target MS, based upon the location information for the target MS 108, as well as the location information of the plurality of reporting devices. In another embodiment, the LS 106 defines the subset to include all the plurality of reporting devices within range of a cell, or within an area, in which the target MS 108 was last located. In yet another embodiment, the LS 106 defines a time period, and then defines the subset to be all reporting devices which obtained location information corresponding to the target MS 108 during the time period. It will be appreciated that, depending upon design choice and the specific embodiment, the defining of the subset can be performed wholly in the LS 106, wholly in the reporting devices (MSs 108 and FRDs 110), or distributed between the LS 106 and the reporting devices.

The memory 408 further comprises an eliciting program 414 for identifying the target MS 108 to the subset; and requesting, through well-known communication techniques, the subset to report the location information corresponding to the target MS 108. In addition, the memory 408 includes a combining program 416 for programming the processor 404 to extrapolate a current location of the target MS 108 from a last reported location and time and at least one other reported location and time. For example, when the target MS 108 was at location X at 1:00 PM; and was at location Y, 10 kilometers directly east of X at 1:10 PM; then it may be reasonably extrapolated that the target MS 108 will be at or near location Z, 20 kilometers directly east of X, at 1:20 PM, assuming that the velocity and/or direction of the target MS does not change significantly after location Y. Extrapolation may also use knowledge in the system 100 about the local geometry and topology, as well as velocity information included in the reported location information.

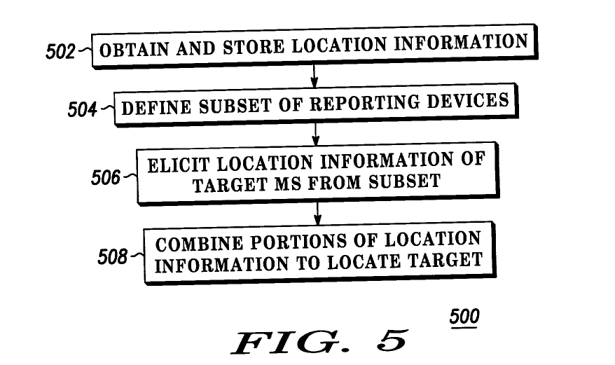

FIG. 5 is a flow diagram depicting operation of the wireless communication system 100 in accordance with the present invention. First, the system 100 obtains 502 and stores location information corresponding to a target MS 108 in a plurality of reporting devices (other MSs 108 and FRDs 110) and in the LS 106 of the wireless communication system. When the system 100 needs to locate a target MS 108, the system 100 defines 504 a subset of the plurality of reporting devices that can reasonably be expected to be near the target MS 108, through techniques described herein above. The system 100 then elicits 506 the location information corresponding to the target MS 108 from the subset. The system combines 508 relevant portions of the received location information to determine the location of the target MS 108.

It should be clear from the preceding disclosure that the present invention provides a method and apparatus that can determine and report the location of the MS when the MS is out of coverage of the wireless system or when the MS cannot determine its location. Advantageously, the accuracy of the reported location is high, provided that a reporting device that communicated recently with the target MS can be found.

Many modifications and variations of the present invention are possible in light of the above teachings. Thus, it is to be understood that, within the scope of the appended claims, the invention can be practiced other than as specifically described herein above.

What is claimed is:

1. A method in a wireless communication system for determining a location of a mobile station (MS), the method comprising the steps of:
obtaining and storing location information corresponding to a target MS in a plurality of reporting devices and in a location server of the wireless communication system;
defining a subset of the plurality of reporting devices;
eliciting the location information corresponding to the target MS from the subset; and
combining portions of the location information to determine the location of the target MS.

2. The method of claim 1,
wherein the location of each of the plurality of reporting devices is known to at least one of the reporting device and the location server, and
wherein the defining step comprises the step of defining the subset to include the plurality of reporting devices whose locations are less than a predetermined distance from the target MS, as estimated based upon the location information.

3. The method of claim 1, wherein the defining step comprises the step of
defining the subset to include all the plurality of reporting devices within range of one of a cell and an area, in which the target MS was last located.

4. The method of claim 1, wherein the defining step comprises the steps of:
defining a time period; and
defining the subset to be all reporting devices which obtained location information corresponding to the target MS during the time period.

5. The method of claim 1, wherein the defining step is performed in a portion of the wireless communication system exclusive of the plurality of reporting devices.

6. The method of claim 1, wherein the defining step is performed in the plurality of reporting devices according to a set of subset-selection rules.

7. The method of claim 1, wherein the eliciting step comprises the steps of:
identifying the target MS to the subset; and
requesting the subset to report the location information corresponding to the target MS.

8. The method of claim 1,
wherein the location information includes a time stamp identifying when the target MS was at a reported location, and
wherein the combining step comprises the step of extrapolating a current location of the target MS from a last reported location and time and at least one of another reported location and time, and a reported velocity.

9. The method of claim 1, wherein the obtaining and storing step comprises the steps of:
communicating between a reporting device and the target MS over a short-range link; and
storing the location of the reporting device as the location of the target MS.

10. The method of claim 1, further comprising in a reporting device the steps of:
receiving a request to report the location information corresponding to the target MS; and
attempting to contact the target MS to determine the location of the target MS, in response to receiving the request.

11. A location server in a wireless communication system for determining a location of a mobile station (MS), the location server comprising:
a communication interface;
a processor coupled to the communication interface for controlling the communication interface to communicate with a target MS and with a plurality of reporting devices to obtain location information corresponding to the target MS; and
a database coupled to the processor for storing the location information,
wherein the processor is programmed to:
define a subset of the plurality of reporting devices;
elicit the location information corresponding to the target MS from the subset; and
combine portions of the location information to determine the location of the target MS.

12. The location server of claim 11,
wherein the location of each of the plurality of reporting devices is known to at least one of the reporting device and the location server, and
wherein the processor is further programmed to define the subset to include the plurality of reporting devices whose locations are less than a predetermined distance from the target MS, as estimated based upon the location information.

13. The location server of claim 11, wherein the processor is further programmed to define the subset to include all the plurality of reporting devices within range of one of a cell and an area, in which the target MS was last located.

14. The location server of claim 11, wherein the processor is further programmed to:
identify the target MS to the subset; and
request the subset to report the location information corresponding to the target MS.

15. The location server of claim 11,
wherein the location information includes a time stamp identifying when the target MS was at a reported location, and
wherein the processor is further programmed to extrapolate a current location of the target MS from a last reported location and time and at least one of another reported location and time, and a reported velocity.

16. A reporting device in a wireless communication system for determining a location of a mobile station (MS), the reporting device comprising:
a processor for controlling the reporting device, the processor comprising a memory; and
a transceiver coupled to the processor for cooperating with the processor to communicate with a target MS for obtaining and storing in a memory location information corresponding to the target MS,
wherein the processor is programmed to cooperate with the transceiver to:
receive from a location server of the wireless communication system a message eliciting the location information corresponding to the target MS from a subset of a plurality of reporting devices; and
communicate the location information to the location server when the reporting device is a member of the subset.

17. The reporting device of claim 16 further comprising
a location determining element coupled to the processor for determining the location of the reporting device,
wherein the processor is further programmed to:
control the transceiver to limit communication range between the reporting device and the target MS to that of a short-range link;
communicate with the target MS; and
store the location of the reporting device as the location of the target MS.

18. The reporting device of claim 16, wherein the processor is further programmed to:
receive a request to report the location information corresponding to the target MS; and
attempt to contact the target MS to determine the location of the target MS, in response to receiving the request.

19. The reporting device of claim 16, wherein the reporting device is a mobile wireless device similar to the target MS.

20. The reporting device of claim 16, wherein the reporting device is a fixed wired device.
